(19) United States
(12) Patent Application Publication
(10) Pub. No.: US 2009/0254369 A1
(43) Pub. Date: Oct. 8, 2009

(54) SYSTEM AND METHOD FOR PROVIDING HEALTH CARE SERVICES USING SMART HEALTH CARDS

(76) Inventor: A. Hassan Mohaideen, Staten Island, NY (US)

Correspondence Address: PILLSBURY WINTHROP SHAW PITTMAN, LLP, P.O. BOX 10500, MCLEAN, VA, 22102, US

(21) Appl. No.: 12/171,953

(22) Filed: Jul. 11, 2008

Related U.S. Application Data
(63) Continuation-in-part of application No. 12/099,491, filed on Apr. 8, 2008.

(51) Int. Cl. G06Q 50/00; G06Q 10/00

(52) U.S. Cl. 705/3

(57) ABSTRACT

A system and method for providing health care services using smart health cards, for example, subscriber identity module (SIM) cards is provided. Smart health cards include at least member information. When a member visits a provider, the smart health card is read to obtain the member information and the retrieved member information is used to generate HIPAA compliant EDI transactions.

### RELATED APPLICATIONS

This application claims the benefit of U.S. patent application Ser. No. 12/099,491 filed Apr. 8, 2008, which is hereby incorporated herein by reference in its entirety.

### FIELD OF THE INVENTION

The invention relates generally to a system and method for providing health care services using smart health cards, including for example, subscriber identity module (SIM) cards, wherein information in the smart health cards may be used to generate HIPAA compliant Electronic Data Interchange (EDI) transactions.

### BACKGROUND OF THE INVENTION

Conventional systems for providing health care services in the health care industry require various entities (e.g., members, providers, employers, payers, etc.) involved in the process to deal with large amounts of information manually. For example, providers require members to manually provide information associated with the members, providers manually maintain files including member information, providers manually process claims for payers, etc. A significant amount of time is expended for such manual operations.

Furthermore, member information is typically maintained at an office of the provider and the member is typically not provided with access to the member information. Thus, anytime a member may want to update his member information, he typically must do so either by calling or by visiting the provider, which in turn leads to frustration.

These and other drawbacks exist.

### SUMMARY OF THE INVENTION

The invention relates to a system and method for providing health care services using smart health cards. A smart health card may be issued to a member who upon visiting a provider for diagnosis and treatment may provide the smart health card to the provider. The smart health card may include among other information, member information including health-related information, demographic information, member's provider information, and member's employer information. The smart health card may also include electronic forms associated with HIPAA compliant Electronic Data Interchange (EDI) transactions, or other information. The provider may read the smart health card to obtain the member information associated with the member. The obtained member information may be used to generate HIPAA compliant EDI transactions between the provider and a payer.

Each of the HIPAA compliant EDI transactions may be associated with corresponding electronic forms that may be retrieved from the provider's local system, a remote server or the smart health card. A HIPAA compliant EDI transaction may be generated by the provider by: retrieving an electronic form associated with the transaction, and populating the retrieved electronic form with the member information obtained from the smart health card. The populated electronic form may then be forwarded to the payer, either directly or via a third-party service provider.

According to various implementations of the invention, the provider may use the demographic information in the smart health card to populate an electronic form associated with a HIPAA complaint eligibility request transaction prior to performing an examination of the member and forward the request to the payer. The payer, upon verification of eligibility, may send a HIPAA compliant eligibility response to the provider. The provider may choose to treat an eligible member.

According to various implementations of the invention, the provider may use the demographic information and the provider information in the smart health card to populate an electronic form associated with a HIPAA complaint claim transaction after performing an examination of the member and may forward the request to the payer. The payer, upon processing the claim, may send a HIPAA compliant claim response to the provider.

According to various implementations of the invention, the contents of the smart health card may be derived from a remote server that is updated by providers and/or members to whom the smart health card is issued. When a smart health card is read by the provider, alerts regarding any updates to member information available at the remote server for the member may be provided to the provider. The smart health card may accordingly be updated such that the provider may have access to the most current member information associated with the member.

According to various implementations of the invention, upon examination of the member by the provider, various information, including member information, on the smart health card may be updated based on the diagnosis and treatment. The updated information, including updated member information, on the smart health card may be synchronized with information, including member information, at the remote server.

According to various implementations of the invention, one or more payers and one or more employers may be registered with a third-party service provider on a contractual basis. The payers may have one or more participating providers and one or more participating members and the employers may employ and sponsor the one or more members. The payers, employers, providers and members may provide information to the third-party service provider. The information provided by the payer may include, for example, payer profile information, participating member information, participating provider information, or other information. The information provided by the employer may include, for example, employer profile information, participating member information, or other information. The information provided by the provider may include, for example, provider profile information, information regarding the payers it is participating with, rendering provider information, or other information.

According to various implementations of the invention, initial information regarding a member may be provided by either a payer or an employer or both to the third-party service provider. This initial information may include, but is not limited to, demographic information, contact information, health coverage information, dependent information, health insurance eligibility information, provider information, employer information, and/or other information.

The member may provide personal information, health-related information or other member information to the third-party provider. The member information may be included in a smart health card that is issued to the member by the third-party service provider. Other information, for example, electronic forms associated with HIPAA compliant EDI transactions, etc., may also be included in the smart health card by the third-party provider.

According to various implementations of the invention, when a participating member visits a provider for diagnosis and treatment, the smart health card issued to the member may be read by the provider and electronic forms associated with HIPAA compliant EDI transactions may be automatically populated. These populated electronic forms may be forwarded to a remote server associated with the third-party service provider and the third-party service provider may forward the forms to the payer. The forms may be forwarded to the remote server in real-time or in a batch mode.

According to some implementations of the invention, a portable/removable integrated circuit card (ICC), such as, for example, a Subscriber Identity Module (SIM) card may be utilized as the smart health card.

SIM cards are known to be used with, for example, mobile phones, mobile computers, and/or other mobile devices. A SIM card is usually inserted into a mobile device, and when the mobile device is switched on, information from the SIM card is utilized to gain access to a mobile operator's network. A SIM card may store information including personal identity information, cellular phone number, phone book, text messages, network specific information used to authenticate and identify subscribers on the network (for example, Integrated Circuit Card ID (ICCID), International Mobile Subscriber Identity (IMSI), Authentication Key (Ki), Local Area Identity (LAI) and Operator-Specific Emergency Number), and/or other information. A SIM card may be used with multiple mobile devices by simply removing the SIM card from one mobile device and inserting it into another mobile device without loss of information stored in the SIM card. Global SIM cards are also available for use throughout the world.

According to some implementations of the invention, the member may use a mobile device with a SIM card, wherein the SIM card may also serve as the member's smart health card. In these implementations, the SIM card may additionally include among other information, the information stored on the smart health card as described above (for example, member's health-related information, member's demographic information, member's provider information, member's employer information, or other member information). The SIM card may also include the electronic forms associated with HIPAA compliant EDI transactions, or other information.

According to some implementations of the invention, when the member with the mobile device that includes the SIM card, visits the provider for diagnosis and treatment, the provider may access the SIM card to obtain the member information associated with the member. This may be accomplished via various communications links associated with the mobile device in which the SIM card operates. This may also be accomplished by reading the SIM card directly (e.g., by removing the SIM card from the mobile device and inserting the SIM card into a reader at the provider). In one implementation, member information from the SIM card may be accessed by the provider via Bluetooth communication links. In one implementation, member information from the SIM card may be accessed by the provider by transferring the member information to a provider computer using USB cable. In one implementation, the provider may directly access the member information via a display of the mobile device. The obtained member information may be used to generate HIPAA compliant EDI transactions between the provider and the payer.

Each of the HIPAA compliant EDI transactions may be associated with corresponding electronic forms that may be retrieved from the provider's local system, a remote server or the SIM card. A HIPAA compliant EDI transaction may be generated by the provider and/or the mobile device by: retrieving an electronic form associated with the transaction, and populating the retrieved electronic form with the member information obtained from the SIM card. The populated electronic form may then be forwarded by the provider and/or the mobile device to the payer, either directly or via a third-party service provider.

Objects, features, and advantages of the invention will be apparent throughout the detailed description and the drawings attached thereto. It is also to be understood that the foregoing summary and the following detailed description are exemplary and not restrictive of the scope of the invention.

### BRIEF DESCRIPTION OF THE DRAWINGS

FIG. 1 is an exemplary illustration of various entities involved in providing health care services to members, according to various implementations of the invention.

FIG. 2 is an exemplary illustration of various application modules at a third-party service provider according to various implementations of the invention.

FIG. 3 is an exemplary illustration of various application modules at a provider according to various implementations of the invention.

FIG. 4 is an exemplary illustration of a flowchart of processing operations which may be performed at provider, according to various implementations of the invention.

FIG. 5 is an exemplary illustration of a flowchart of processing operations which may be performed at third-party service provider, according to various implementations of the invention.

FIG. 6 is an exemplary illustration of various application modules at a mobile device, according to various implementations of the invention.

### DETAILED DESCRIPTION OF THE INVENTION

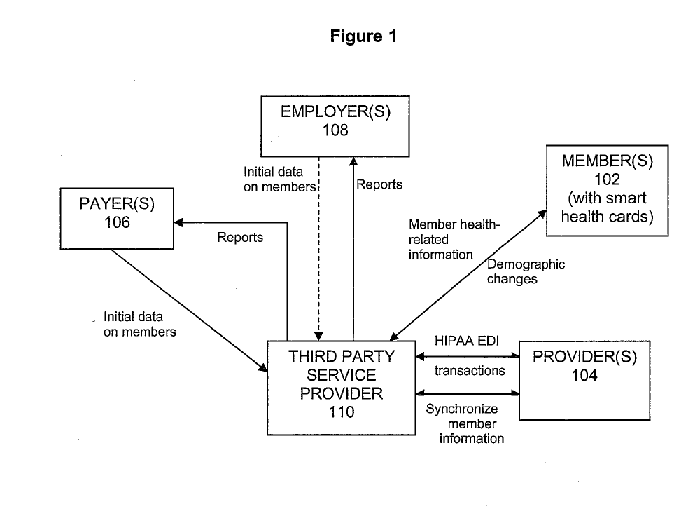

FIG. 1 illustrates a setup for providing health care services to member(s) 102 using smart health cards. In some implementations of the invention, various entities, for example, provider(s) 104, payer(s) 106, employer(s) 108, third-party service provider(s) 110, and/or other entities, play a role in providing health care services to members.

Member(s) 102 may visit provider(s) 104 (e.g., primary care physicians and/or other health care providers) for diagnosis and treatment. Payer(s) 106 (e.g., insurance companies and/or other payer entities) may have one or more participating providers 104 and one or more participating members 102. Employer(s) 108 may employ and sponsor one or more members 102. Payer(s) 106 and employer(s) 108 may be registered with a third-party service provider 110 on a contractual basis.

According to some implementations of the invention, Initial information about member 102 may be provided to third-party service provider 110 by payer 106, employer 108, both payer 106 and employer 108, and/or other entities. This initial information regarding member 102 may include, but is not limited to, demographic information, contact information, health coverage information, dependent information, health insurance eligibility information, provider information, employer information, and/or other information.

According to some implementations of the invention, member 102 may view, add to, and/or update the initial member information provided to third-party service provider 110. Member 102 may provide additional member information including personal information, health-related information, or other information to third-party service provider 110. Health-related information may include, but is not limited to, medical history information, allergy information, information regarding provider visits, information regarding treatments, prescription information, medical reports, medical images (e.g., X-rays) and/or other health-related information.

According to some implementations of the invention, third-party service provider 110 may issue a smart health card to member 102. The smart health card may include among other information, member information including demographic information, health-related information, member's provider information, member's employer information, and/or other member information, electronic forms associated with HIPAA compliant EDI transactions, and/or other information. During the member's visits to provider 104, provider 104 may read the member's smart health card to obtain the member information. Provider 104 may utilize the obtained member information to generate HIPAA compliant EDI transactions. In some implementations of the invention, provider 104 may forward the transactions to payer 106 directly. In some implementations of the invention, provider 104 may forward the transactions to payer 106 via third-party service provider 110. In some implementations of the invention, the transactions are forwarded in real-time or in batch mode.

According to some implementations of the invention, upon completing the examination of member 102, member information may be updated by provider 104 based on diagnosis and treatment. In some implementations of the invention, member's health-related information may be updated by provider 104 to include details regarding member's visit, details regarding treatment, prescriptions, and/or other information. In some implementations of the invention, provider 104 may update the smart health card with the updated member information. In some implementations of the invention, provider 104 may provide updated member information to a remote server associated with third-party service provider 110, such that member's information is updated at and synchronized with the remote server.

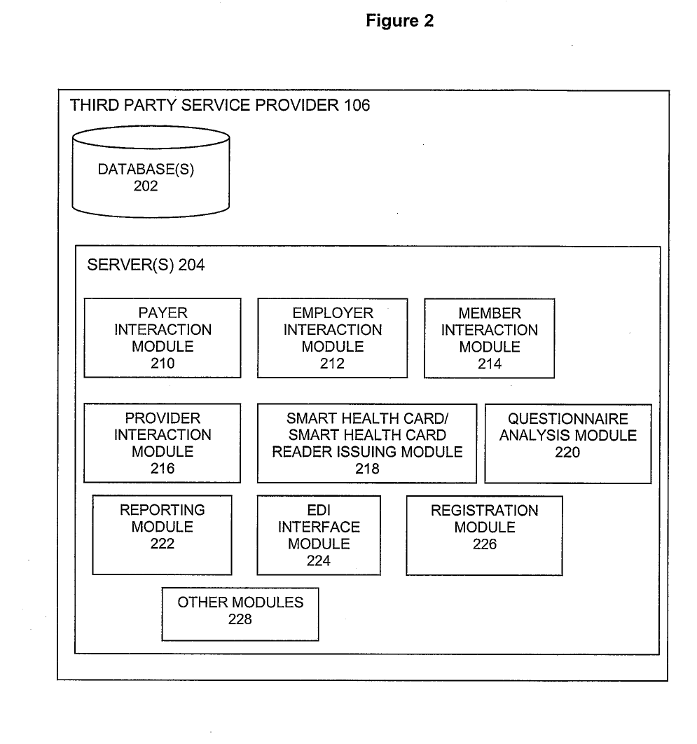

According to various implementations of the invention, and with reference to FIG. 2, third-party service provider 110 may include one or more servers 204 in operative communication with one or more databases 202. Server 204 may comprise one or more application modules that may provide features and functionality of the invention. For example, the one or more application modules may perform functions including one or more of: facilitating issuance of smart health cards, facilitating issuance of smart health card readers, interacting with and receiving information from members 102, interacting with and receiving information from payers 106, interacting with and receiving information from employers 108, interacting with and receiving information from providers 104, providing EDI interface, analyzing medical history questionnaires, reporting, or other functions.

According to various implementations of the invention, these application modules may include one or more of a payer interaction module 210, employer interaction module 212, member interaction module 214, provider interaction module 216, smart health card/smart health card reader issuing module 218, questionnaire analysis module 220, reporting module 222, EDI interface module 224, registration module 226, or other modules 228. In some implementations of the invention, one or more of the modules may be combined. In some implementations of the invention, not all modules may be necessary.

In some implementations of the invention, databases 202 may comprise, include, or interface to one or more databases or other data storage or query formats, platforms, or resources for storing (and retrieving) various types of data, as described in greater detail herein. Databases 202 may store member information, payer information, employer information, provider information, medical history questionnaires, reports, electronic forms associated with HIPAA compliant EDI transactions, member eligibility files associated with member information, and/or other information.

In some implementations of the invention, payer interaction module 210 may interact with payers 106 to receive registration information regarding payers' participating providers 104 and participating members 102.

In some implementations of the invention, payer interaction module 210 may interact with payers 106 to receive information associated with the payers 106. Payer interaction module 210 may also receive updates (additions, deletions, changes, and/or other updates) to the payer information. Payer information may include, but it not limited to, payer name, registrant name, federal tax id, contact information, billing information, and/or other information. Payer interaction module 210 may store the received payer information at database 202.

In some implementations of the invention, payer interaction module 210 may interact with payers 106 to receive requests to view payer information. In response to the received requests, payer interaction module 210 may, retrieve payer information from database 202 and provide views of payer information (for example, in tabular format, or any other format) to payers 106.

In some implementations of the invention, payer interaction module 210 may interact with payers to receive initial member information associated with their participating members 102. Payer interaction module 210 may also receive updates (additions, deletions, changes, and/or other updates) to the initial member information. The initial member information may include, but is not limited to, demographic information, contact information, health coverage information, dependent information, health insurance eligibility information, provider information, employer information, and/or other information. Payer interaction module 210 may store the received initial member information at database 202.

In some implementations of the invention, payer interaction module 210 may interact with payers to receive requests to view member information. In response to the received requests, payer interaction module 210 may, retrieve member information from database 202 and provide views of member information (for example, in tabular format, or any other format) to payers 106.

In some implementations of the invention, payer interaction module 210 may interact with payers to receive information associated with their participating providers 104. Payer interaction module 210 may also receive updates (additions, deletions, changes, and/or other updates) to the provider information. The provider information may include, but it not limited to, provider name, practice name, national provider ID, federal tax id, contact information, billing information, and/or other information. Payer interaction module 210 may store the received provider information at database 202.

In some implementations of the invention, payer interaction module 210 may interact with payers to receive requests to view provider information. In response to the received requests, payer interaction module 210 may, retrieve the provider information from database 202 and provide views of provider information (for example, in tabular format, or any other format) to payers 106.

In some implementations of the invention, payer interaction module 210 may interact with payers 106 to receive member eligibility files which may be in a HIPAA compliant format. The member eligibility files may be associated with the member information and payer interaction module may store the files at database 202.

In some implementations of the invention, payers 106 may comprise corresponding third-party service provider interaction modules (not shown) that may enable payers 106 to provide registration information regarding payer's participating providers 104 and participating members 102; may enable payers 106 to provide, view, add to, or update information associated with payers 106; may enable payers 106 to provide, view, add to, or update initial member information associated with participating members 102; may enable payers 106 to provide, view, add to, or update information associated with participating providers 104; may enable payers to upload member eligibility files; and/or perform other functions.

In some implementations of the invention, payer interaction module 210 may interact with payers 106 via a website hosted by server 204 that may include one or more web pages dedicated for payers 106.

In some implementations of the invention, employer interaction module 212 may interact with employers 108 to receive registration information regarding employers' participating members 102.

In some implementations of the invention, employer interaction module 212 may interact with employers 108 to receive information associated with the employers 108. Employer interaction module 212 may also receive updates (additions, deletions, changes, and/or other updates) to the employer information. Employer information may include, but it not limited to, employer name, federal tax id, contact information, billing information, and/or other information. Employer interaction module 212 may store the received employer information at database 202.

In some implementations of the invention, employer interaction module 212 may interact with employers 108 to receive requests to view employer information. In response to the received requests, employer interaction module 212 may retrieve the employer information from database 202 and provide views of employer information (for example, in tabular format, or any other format) to employers 108.

In some implementations of the invention, employer interaction module 212 may interact with employers 108 to receive initial member information associated with their participating members 102. Employer interaction module 212 may also receive updates (additions, deletions, changes, and/or other updates) to the initial member information. The initial member information may include, but it not limited to, demographic information, contact information, health coverage information, dependent information, health insurance eligibility information, provider information, employer information, and/or other information. Employer interaction module 212 may store the received member information at database 202.

In some implementations of the invention, employer interaction module 212 may interact with employers 108 to receive requests to view the member information. In response to the received requests, employer interaction module 212 may retrieve the member information from database 202 and provide views of the member information (for example, in tabular format, or any other format) to employers 108.

In some implementations of the invention, employer interaction module 212 may interact with employers 108 to receive member eligibility files which may be in a HIPAA compliant format. The member eligibility files may be associated with the member information and employer interaction module 212 may store the files at database 202.

In some implementations of the invention, employers 108 may comprise corresponding third-party service provider interaction modules (not shown) that may enable employers 108 to provide registration information regarding employers' participating members 102; may enable employers 108 to provide, view, add to, or update information associated with employers 108; may enable employers 108 to provide, view, add to, or update information associated with participating members 102; may enable employers to upload member eligibility files; and/or perform other functions.

In some implementations of the invention, employer interaction module 212 may interact with employers 108 via a website hosted by server 204 that may include one or more web pages dedicated for employers 108.

In some implementations of the invention, initial member information associated with participating members 102 may be received from either payers 106, or employers 108, or both.

In some implementations of the invention, member interaction module 214 may interact with participating members 102 to receive updates (additions, deletions, changes, and/or other updates) to the initial member information, including, but not limited to, demographic information. Member interaction module 214 may interact with participating members 102 to receive information associated with members' chosen participating providers 104. Member interaction module 214 may interact with participating members 102 to receive health-related information associated with participating members 102. Health-related information may include, but is not limited to, medical history information, allergy information, information regarding provider visits, information regarding treatments, prescription information, medical reports, medical images (e.g., X-rays) and/or other health-related information. Member interaction module 214 may store the received information at database 202.

In some implementations of the invention, member interaction module 214 may retrieve a medical history questionnaire from database 202; may provide the medical history questionnaire to participating members 102 for completion; and may receive medical history information associated with the participating members 102 via completed the medical history questionnaire.

In some implementations of the invention, member interaction module 214 may interact with participating members 102 to receive requests to view member information. In response to the received requests, member interaction module 212 may retrieve the member information from database 202 and provide views of member information (for example, in tabular format, or any other format) to participating members 102.

In some implementations of the invention, participating members 102 may comprise corresponding third-party service provider interaction modules (not shown) that may enable members 102 to provide, view, add to, or update information associated with members 102; and/or perform other functions.

In some implementations of the invention, member interaction module 214 may interact with participating members 102 via a website hosted by server 204 that may include one or more web pages dedicated for members 102.

In some implementations of the invention, when members 102 access the website via the web pages dedicated for members 102 for the first time, members may view, add to, or update the initial member information. Subsequently, member 102 may periodically access the website to view member information (including the initial information obtained from the payer 106 and/or employer 108 and health-related information entered by member 102) and to add to or update the member information to ensure that it is up-to-date.

In some implementations of the invention, provider interaction module 216 may interact with participating providers 104 to receive information associated with the providers 104. Provider interaction module 216 may also receive updates (additions, deletions, changes, and/or other updates) to the provider information. The provider information may include, but it not limited to, provider name, practice information, national provider ID, federal tax id, contact information, billing information, insurance company information, billing provider information, rendering provider information, and/or other information. Provider interaction module may store the received provider information at database 202.

In some implementations of the invention, provider interaction module 216 may interact with participating providers 104 to receive member information associated with participating members 102 who visit participating providers 104 for diagnosis and treatment (i.e., participating members who are participating providers' patients). Provider interaction module may interact with participating providers 104 to receive updates (additions, deletions, changes, and/or other updates) to the member information.

In some implementations of the invention, provider interaction module 216 may interact with participating providers 104 to receive updates (additions, deletions, changes, and/or other updates) regarding details associated with one or more visits that participating members 102 made to the participating providers 104, treatment information, prescription information, and/or other information. Provider interaction module may store the received information at database 202.

In some implementations of the invention, provider interaction module 216 may receive requests to view and/or search for: provider information; details associated with one or more visits that participating members made to the participating providers 104; payer information associated with payers 106 with whom the participating providers are registered; transactions related to the provider's claims (e.g., claim request, claim response, claim status request, claim status response, and/or other transactions). The above-mentioned information may be maintained at database 202.

In some implementations of the invention, in response to the received requests, provider interaction module 216 may, retrieve the requested information from database 202 and provide views of the results (for example, in tabular format, or any other format) to participating providers 104.

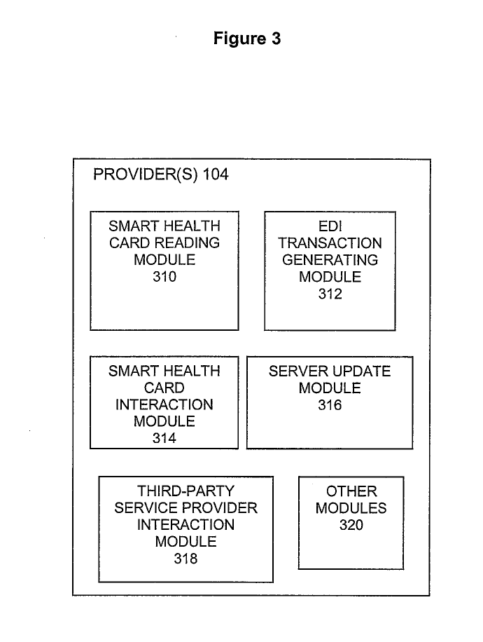

In some implementations of the invention, participating providers 104 may comprise corresponding third-party service provider interaction modules (described with respect to FIG. 3) that may enable providers 104 to provide, view, search for, add to, or update information associated with participating members 102 and providers 104; and/or perform other functions.

In some implementations of the invention, provider interaction module 216 may interact with participating providers 104 via a website hosted by server 204 that may include one or more web pages dedicated for participating providers 104.

In some implementations of the invention, payer interaction module 210, employer interaction module 212, member interaction module 214, and/or other modules may generate alerts for any updates received from payers 106, employers 108, participating members 102, and/or other entities. Provider interaction module 216 may receive these alerts and create alert packages associated with participating members 102.

In some implementations of the invention, smart health card/smart health card reader issuing module 218 may issue smart health cards to participating members 102 and issue smart health card readers to participating providers 104. Smart health card/smart health card reader issuing module 218 may retrieve information including, but not limited to, members' demographic information, members' health-related information, members' employer information, members' provider information, electronic forms associated with HIPAA compliant EDI transactions, from database 202 and issue the smart health cards including the retrieved information to participating members 102.

In some implementations of the invention, questionnaire analysis module 220 may associate rules with a medical history questionnaire to be completed by participating members 102 and may analyze the completed medical history questionnaire to determine whether the information entered by the participating members 102 satisfies the associated rules. In some implementations of the invention, the rules may be associated with the medical history questionnaire to provide an indication of which fields in the questionnaire are to be made private or critical.

In some implementations of the invention, reporting module 222 may generate reports of: payers 106 including payer information associated with payers 106; employers 108 including employer information associated with employers 108; members 102 including member information associated with members 102; providers 104 including provider information associated with providers 104; member visits including details of the visits of members 102 to providers 104 for diagnosis and treatment; smart health card status including details of date of card creation, mailing for members 102, and/or other details; HIPAA compliant EDI transactions generated by participating providers 104 including provider identification, details of transactions, corresponding transaction identifier, and/or other information.

In some implementations of the invention, EDI interface module 224 may receive and/or track HIPAA compliant EDI transactions generated by providers 104 for payers 106 or generated by payers 106 for providers. EDI interface module 224 may forward the received transactions from providers 104 to payers 106 and forward the received transactions from payers 106 to providers 104. HIPAA compliant EDI transactions generated by providers 104 for payers 106 may include, but not be limited to, member eligibility requests, claim requests, claim status requests, and/or other transactions. HIPAA compliant EDI transactions generated by payers 106 for providers 104 may include, but not be limited to, member eligibility response, claim response, claim status response, and/or other transactions.

In some implementations of the invention, EDI interface module 224 may track a received transaction by assigning a transaction identifier to the received transaction and associating with the received transaction, provider identification information associated with the provider who generated the transaction.

In some implementations of the invention, EDI interface module 224 may process the transactions and not forward the transactions to payers 106. For example, to determine whether a member is eligible for health care services, a provider may generate a member eligibility request transaction. EDI interface module 224 may receive the member eligibility request, may determine whether a member eligibility file associated with the member exists in database 202, and may respond to the member eligibility request by generating a member eligibility response to the provider indicating that the member is an eligible member.

In some implementations of the invention, registration module 226 may receive registration information from payers 106, employers 108, and/or other entities. Registration information from payers 106 may include payers' registration information, registration information regarding payers' participating providers 104, registration information regarding payers' participating members 102, and/or other registration information. Registration information from employers 108 may include employers' registration information, information regarding employers' participating members, and/or other registration information. Registration module 226 may register payers 106, employers 108, members 102, and providers 104 with third-party service provider 110.

In some implementations of the invention, payers 106 and employers 108 may be registered with third-party service provider on a contractual basis.

In some implementations of the invention, and with reference to FIG. 3, provider(s) 104 may comprise a local provider system (not shown) configured to run an application (not shown) comprising one or more application modules that may enable various features and functionality of the invention. For example, the one or more software modules may perform functions including one or more of: reading smart health cards, updating member information on smart health card and remote server, generating HIPAA compliant EDI transactions, or other functions.

According to various implementations of the invention, these application modules may include one or more of a smart health card reading module 310, EDI transaction generating module 312, smart health card interaction module 314, server update module 316, third-party service provider module 318, or other modules 320. In some implementations of the invention, one or more of the modules may be combined. In some implementations of the invention, not all modules may be necessary.

In some implementations of the invention, smart card reading module 310 may read smart health cards issued to members 102. When a member visits a provider 104 for diagnosis and treatment and presents a smart health card, the smart health card may be read by smart card reading module 310 to obtain member information.

In some implementations of the invention, EDI transaction generating module 312 may generate HIPAA compliant EDI transactions by utilizing the member information obtained from the smart health card via smart health card reading module 310. EDI transaction generating module 312 may generate a HIPAA compliant EDI transaction by: retrieving an electronic form associated with the HIPAA compliant EDI transaction; and populating the retrieved electronic form with the member information obtained from the smart health card. HIPAA compliant EDI transactions generated by EDI transaction generating module 312 may include, but are not limited to, member eligibility requests, claim requests, claim status requests, and/or other transactions.

In some implementations of the invention, EDI transaction generating module 312 may retrieve the electronic form associated with the HIPAA compliant EDI transaction from at least one of: the smart health card, a memory in the local provider system, or database 202 associated with remote server 204.

In some implementations of the invention, EDI transaction generating module 312 may forward the populated electronic form associated with the HIPAA compliant EDI transaction to payer 106 either directly or via third-party service provider 110.

In some implementations of the invention, EDI transaction generating module 312 may receive HIPAA compliant EDI transactions from payer 106 either directly or via third-party service provider 110. The received HIPAA compliant EDI transactions may include, but are not limited to, member eligibility responses, claim responses, claim status responses, and/or other transactions. The received HIPAA compliant EDI transactions may be received in response to the populated electronic forms that were forwarded by EDI transaction generating module 312. In some implementations of the invention, prior to examination of a member 102 by provider 104, a HIPAA compliant member eligibility request may be generated by EDI transaction generating module 312. EDI transaction generating module 312 may retrieve an electronic form associated with the HIPAA compliant member eligibility request and may populate the electronic form with the member's demographic information obtained from the smart health card via smart health card reading module 310.

In some implementations of the invention, EDI transaction generating module 312 may receive a HIPAA compliant eligibility response in response to the HIPAA compliant member eligibility request.

In some implementations of the invention, after examination of member 102 by provider 104, a HIPAA compliant claim request may be generated by EDI transaction generating module 312. EDI transaction generating module 312 may retrieve an electronic form associated with the HIPAA compliant claim request and may populate the electronic form with the member's demographic and provider information obtained from the smart health card via smart health card reading module 310.

In some implementations of the invention, EDI transaction generating module 312 may receive a HIPAA compliant claim response in response to the HIPAA compliant claim request.

In some implementations of the invention, smart health card interaction module 314 may enable providers 104 to update member information on the smart health card based on diagnosis and treatment. In some implementations of the invention, member's health-related information may be updated by provider 104 to include details regarding member's visit, details regarding treatment, prescriptions, and/or other information.

In some implementations of the invention, smart health card interaction module 314 may retrieve any alert packages available at server 204 for the member whose smart health card is read by smart health card reading module 310. Smart health card interaction module 314 may provide alerts in the retrieved alert packages to providers 104 regarding any updates available at server 204. Accordingly, if any updates are available, smart health card interaction module 314 may update the information on the smart health card appropriately.

In some implementations of the invention, smart health card interaction module 314 adds a service reminder for future medical appointments to the smart health card.

In some implementations of the invention, server update module 316 may update member information directly at the remote server 204 associated with third-party service provider 110. In some implementations of the invention, server update module 316 may update member information by synchronizing updates to member information on the smart health card with member information at the remote server.

In some implementations of the invention, third-party service provider interaction module 318 may enable providers 104 to provide, view, search for, add to, or update information associated with participating members 102 and providers 104; and/or perform other functions.

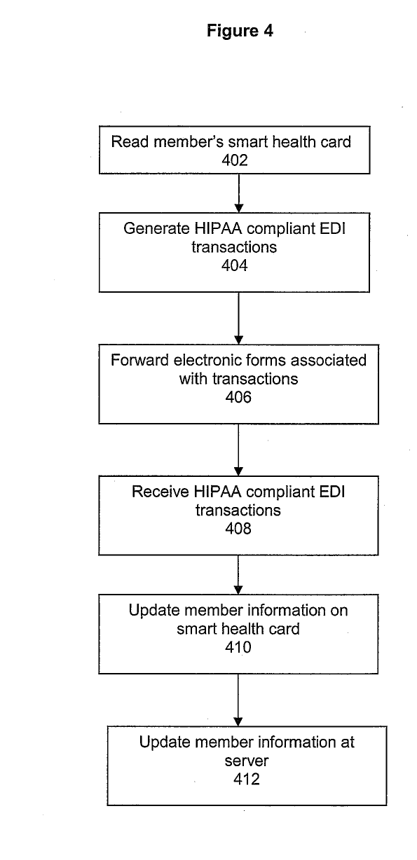

FIG. 4 is an exemplary illustration of a flowchart of processing operations which may be performed at provider 104, according to various implementations of the invention. In some implementations, the described operations may be accomplished in different sequences. In some implementations, additional operations may be performed along with some or all of the operations of FIG. 4. In some implementations, one or more operations may be performed simultaneously.

In operation 402, when a member 102 visits provider 104 for diagnosis and treatment, provider 104 may read the member's smart health card to obtain member information from the smart health card. Member information obtained from the smart health card may include, among other information, demographic information, health-related information, member's provider information, member's employer information, and/or other member information.

In operation 404, provider 104 may generate HIPAA compliant EDI transactions using the member information obtained from the smart health card in operation 402. Provider 104 may generate the HIPAA compliant EDI transactions by: retrieving electronic forms associated with the HIPAA compliant EDI transactions; and populating the retrieved electronic forms with member information obtained from the smart health card.

In some implementations of the invention, the generated HIPAA compliant EDI transactions may include, but are not limited to, member eligibility requests, claim requests, claim status requests, and/or other transactions.

In operation 406, provider 104 may forward the populated electronic forms to payer 106 either directly or via third-party service provider 110. The populated electronic forms may be forwarded in real-time or in batch mode.

In operation 408, provider 104 may receive HIPAA compliant EDI transactions from payer 106 directly or via third-party service provider 110. The received HIPAA compliant EDI transactions are received in response to the electronic formed forwarded in operation 406.

In some implementations of the invention, the received HIPAA compliant EDI transactions may include, but are not limited to, member eligibility responses, claim responses, claim status responses, and/or other transactions.

In operation 410, provider 104 may update member information on the smart health card based in diagnosis and treatment. In some implementations of the invention, member's health-related information may be updated by provider 104 to include details regarding member's visit, details regarding treatment, prescriptions, and/or other information.

In some implementations of the invention, member information may be updated directly at remote server 204 or may be updated by synchronizing the updates to member information on the smart card with member information at the remote server (operation 412).

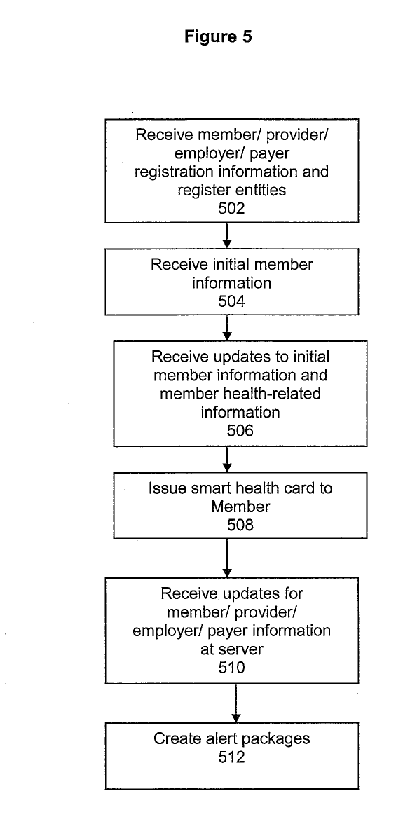

FIG. 5 is an exemplary illustration of a flowchart of processing operations which may be performed at third-party service provider 110 according to some implementations of the invention. In some implementations, the described operations may be accomplished in different sequences. In some implementations, additional operations may be performed along with some or all of the operations of FIG. 5. In some implementations, one or more operations may be performed simultaneously.

In operation 502, third-party service provider 110 may receive registration information for payers 106, employers 108, members 102, and providers 104, and may register these entities.

In operation 504, third-party service provider may receive initial member information from payers 106, employers 108, or both, and/or other entities. This initial member information may include, but is not limited to, demographic information, contact information, health coverage information, dependent information, health insurance eligibility information, provider information, employer information, and/or other information.

In operation 506, third-party service provider may receive updates to the initial member information from member 102. Third-party service provider may also receive health-related information from member 102. Health-related information may include, but is not limited to, medical history information, allergy information, information regarding provider visits, information regarding treatments, prescription information, medical reports, medical images (e.g., X-rays) and/or other health-related information.

In operation 508, third-party service provider may issue a smart health card to member 102. The smart health card may contain among other information, member information including demographic information, health-related information, member's provider information, member's employer information, and/or other member information, electronic forms associated with HIPAA compliant EDI transactions, and/or other information.

In operation 510, third-party service provider 110 may receive updates for information associated with member 102, payer 106, provider 104, and/or employer 108 which is maintained at database 202.

In operation 512, alerts may be generated for any updates received from payer 106, employer 108, member 102, and/or other entities, and alert packages associated with members 102 are created such that whenever a member's smart health card is read at provider 104, the provider 104 is alerted of updates being available at server 204. The smart health card may thus be updated by provider 104 so that information in the smart health card remains current.

According to some implementations of the invention, a portable/removable integrated circuit card (ICC), such as, for example, a Subscriber Identity Module (SIM) card may be utilized as the smart health card.

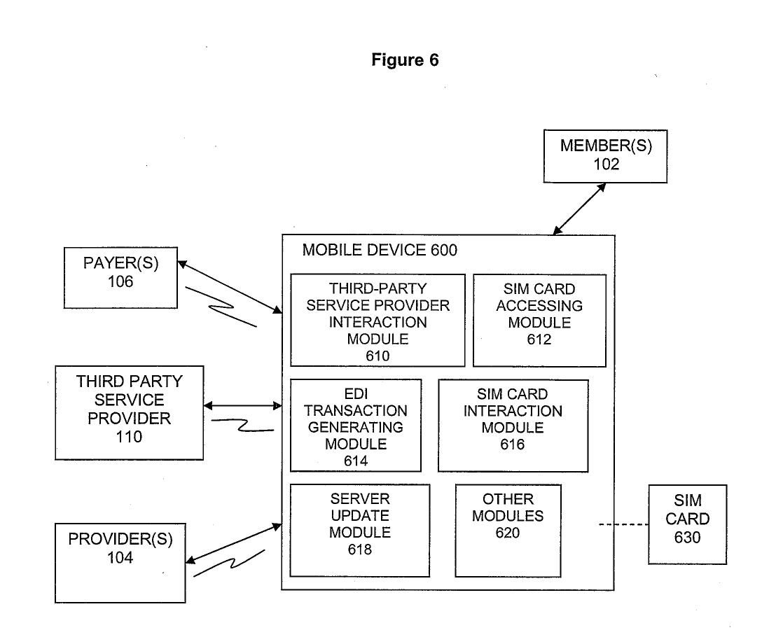

According to some implementations of the invention, and with reference to FIG. 6, member 102 may use a mobile device 600 with a SIM card 630, where the SIM card 630 may implement various features of the smart health card. In these implementations, the SIM card 630 may additionally include among other information, the information included in the smart health card described above (for example, member's health-related information, member's demographic information, member's provider information, member's employer information, and/or other member information). The SIM card 630 may also include the electronic forms associated with HIPAA compliant EDI transactions, and/or other information.

According to some implementations of the invention, when member 102 with the mobile device 600 that includes the SIM card 630, visits provider 104 for diagnosis and treatment, provider 104 may access the SIM card 630 to obtain the member information associated with the member, retrieve electronic forms associated with HIPAA compliant EDI transactions, and/or other information. This may be accomplished via various wired or wireless communications links associated with the mobile device 600 in which the SIM card 630 operates. This may also be accomplished by reading the SIM card 630 directly (e.g., by removing the SIM card 630 from the mobile device 600 and inserting the SIM card 630 into a reader at the provider 104). The obtained member information may be used to generate HIPAA compliant EDI transactions between provider 104 and payer 106.

In some implementations of the invention, as depicted in FIG. 6, mobile device 600 may be configured to run an application (not shown) stored in a memory at the mobile device 600 comprising one or more application modules that may enable various features and functionality of the invention. For example, the one or more software modules may perform functions including one or more of: accessing SIM cards, updating member information on the SIM card and remote server, generating HIPAA compliant EDI transactions, or other functions.

According to various implementations of the invention, these application modules may include one or more of a third-party service provider interaction module 610, SIM card accessing module 612, EDI transaction generating module 614, SIM card interaction module 616, server update module 618, or other modules 620.

According to some implementations of the invention, member 102 may utilize the mobile device 600 to connect to third-party service provider 110 and generate requests to obtain the initial member information provided by either payer 106, or employer 108, or both to third-party service provider 110, via third-party service provider interaction module 610. Any suitable wired or wireless communication links may be used to connect the mobile device 600 to third-party service provider 110. Third-party service provider 110 may receive the requests for initial member information and in response may retrieve the initial member information from database 202, and provide the retrieved information to member's 102 mobile device 600. Third-party service provider interaction module 610 may receive the initial member information from third-party service provider 110 and store obtained initial member information in the SIM card 630 included in the mobile device 600.

According to some implementations, member 102 may utilize member's personal computer (PC) to connect to third-party service provider 110 and generate requests to obtain the initial member information provided by either payer 106, or employer 108, or both to third-party service provider 110. Any suitable wired or wireless communication links may be used to connect the PC to third-party service provider 110. Third-party service provider 110 may receive the requests for the initial member information and in response may retrieve the initial member information from database 202, and provide the retrieved information to member's 102 PC. In some implementations, member's PC may be connected to member's mobile device 600 using any conventional wired or wireless communication links. The obtained initial member information may be downloaded from the PC and stored in the SIM card 630 included in the mobile device 600.

In some implementations of the invention, third-party service provider interaction module 610 may provide member's 102 updates (additions, deletions, changes, and/or other updates) to the initial member information in SIM card 630 to the third-party service provider 110. Third-party service provider interaction module 610 may provide updates associated with member's chosen providers 104, health-related information associated with member 102, and/or other member information.

In some implementations of the invention, member 102 may update the member information, for example, health related information, demographic information, and/or other information, included in the SIM card 630 by directly entering the updated information using the mobile device's keyboard. This updated information may be directly communicated to third-party service provider 110 via third-party service provider interaction module 610. In some implementations, the updated information may be communicated to the PC which in turn may communicate the updated information to third-party service provider 110. Third-party service provider 110 may receive and store the updated member information in database 202. In some implementations, the updated member information from the member may be received and stored in the SIM card 630 via SIM card interaction module 616.

In some implementations of the invention, member information may be maintained at the member's PC and may be synchronized with the member information on the SIM card 630. Member 102 may update the member information maintained at the member's PC. The updated member information may be downloaded from the PC onto the SIM card 630. Then, the updated member information may be communicated to third-party service provider 110 either by the mobile device 600 or the PC.

In some implementations, updated member information from third-party service provider 110 (which may include updates from other entities, for example, providers 104, payers 106, employers 108, and/or other entities) may be received and stored on the SIM card 630 of the mobile device 600 via the third-party service provider interaction module 610. In some implementations, the updated member information from third-party service provider 110 may be received by the PC. The obtained member information may be downloaded from the PC and stored in the SIM card 630 included in the mobile device 600.

According to some implementations of the invention, member 102 may access keys on the mobile device to view member information included in the SIM card. In some implementations, member 102 may utilize the mobile device 600 to generate requests to view the member information maintained at third-party service provider 110, via third-party service provider interaction module 610. Third-party service provider 110 may receive the requests and in response may retrieve the member information from database 202, and provide views of the member information to member's 102 mobile device 600. In some implementations, the requests may be generated via member's PC and views of member information may be provided to the PC.

In some implementations of the invention, third-party service provider 110 may comprise corresponding member interaction modules (for example, member interaction module 214) that may enable third-party service providers 110 to receive requests to obtain member information from the mobile device or PC, retrieve and provide the requested member information to the mobile device or PC, receive updates to the member information from the mobile device or the PC, provide updates to the member information to the mobile device or the PC, receive requests to view member information from the mobile device or the PC, provide the views of member information to the mobile device or PC, and/or other functions.

According to some implementations of the invention, when member 102 with the mobile device 600 including the SIM card 630 visits provider 104 for diagnosis and treatment, provider 104 may access the SIM card 630 to obtain member information from the SIM card 630, for example, via smart health card reading module 310. In some implementations, the member information obtained from the SIM card 630 may include, among other information, demographic information, health-related information, member's provider information, member's employer information, and/or other information. Provider 104 may also retrieve electronic forms associated with HIPAA compliant EDI transactions from the SIM card 630.

According to some implementations of the invention, the mobile device 600 may comprise a SIM card accessing module 612 that may access the SIM card 630 to obtain the member information, the electronic forms associated with HIPAA compliant EDI transactions, and/or other information.

In some implementations, provider 104 may generate HIPAA compliant EDI transactions using the member information obtained from the SIM card 630. EDI transaction generating module 312 at provider 104 may generate the HIPAA compliant EDI transactions by: retrieving an electronic form associated with the HIPAA compliant EDI transaction; and populating the retrieved electronic form with the member information obtained from the SIM card 630. HIPAA compliant EDI transactions generated by EDI transaction generating module 312 may include, but are not limited to, member eligibility requests, claim requests, claim status requests, and/or other transactions. Electronic forms associated with the HIPAA compliant EDI transactions may be retrieved from the provider's local system, remote server, or the SIM card.

In some implementations, EDI transaction generating module 312 may forward the populated electronic form associated with the HIPAA compliant EDI transaction to payer 106 either directly or via third-party service provider 110.

In some implementations of the invention, EDI transaction generating module 312 may receive HIPAA compliant EDI transactions from payer 106 either directly or via third-party service provider 110. The received HIPAA compliant EDI transactions may include, but are not limited to, member eligibility responses, claim responses, claim status responses, and/or other transactions. The received HIPAA compliant EDI transactions may be received in response to the populated electronic forms that were forwarded by EDI transaction generating module 312.

In some implementations of the invention, prior to examination of a member 102 by provider 104, a HIPAA compliant member eligibility request may be generated by EDI transaction generating module 312. EDI transaction generating module 312 may retrieve an electronic form associated with the HIPAA compliant member eligibility request and may populate the electronic form with the member's demographic information obtained from the SIM card 630.

In some implementations of the invention, EDI transaction generating module 312 may receive a HIPAA compliant eligibility response in response to the HIPAA compliant member eligibility request.

In some implementations of the invention, after examination of member 102 by provider 104, a HIPAA compliant claim request may be generated by EDI transaction generating module 312. EDI transaction generating module 312 may retrieve an electronic form associated with the HIPAA compliant claim request and may populate the electronic form with the member's demographic and provider information obtained from the SIM card 630.

In some implementations of the invention, EDI transaction generating module 312 may receive a HIPAA compliant claim response in response to the HIPAA compliant claim request.

According to some implementations of the invention, the mobile device 600 may comprise an EDI transaction generating module 614 similar to the EDI transaction generating module 312 of provider 104. In some implementations, the EDI transaction generating module 614 of the mobile device 600 may generate the HIPAA compliant EDI transactions (for example, member eligibility requests, claim requests, claim status requests, and/or other transactions). EDI transaction generating module 614 at mobile device 600 may generate the HIPAA compliant EDI transactions by: retrieving an electronic form associated with the HIPAA compliant EDI transaction; and populating the retrieved electronic form with the member information obtained from the SIM card 630. In these implementations, the populated electronic forms may be forwarded by the EDI transaction generating module 614 of the mobile device 600 to payer 106 either directly or via third-party service provider 110 using any suitable wired, wireless communications or messaging technologies. In some implementations, at least requisite data associated with the populated electronic forms may be forwarded.

According to some implementations of the invention, EDI transaction generating module 614 may receive HIPAA compliant EDI transactions (for example, member eligibility responses, claim responses, claim status responses, and/or other transactions) from payer 106 either directly or via third-party service provider 110. Electronic forms associated with the HIPAA compliant EDI transactions may be retrieved from the provider's local system, remote server, or the SIM card.

In some implementations of the invention, provider 104 may retrieve, for example, via smart health card interaction module 314, any alert packages available at server 204 for the member whose SIM card 630 is accessed by provider 104. Smart health card interaction module 314 may provide alerts in the retrieved alert packages to providers 104 regarding any updates to the member information available at server 204. Accordingly, if any updates are available, smart health card interaction module 314 may update the information on the SIM card 630 appropriately.

In some implementations, the mobile device 600 may comprise SIM card interaction module 616. The SIM card interaction module 616 may: retrieve alert packages for the member, either prior to, during or after the provider visit; provide alerts to providers 104 during the member's provider visit regarding updates to member information available at server 204 for the member whose SIM card 630 is being accessed; provide alerts to members 102 either prior to, during or after the provider visit regarding any updates available at server 204; and update the information on the SIM card 630 appropriately if updates are available.

In some implementations of the invention, provider 104 may provide updates to the member information based on diagnosis and treatment. In some implementations, the updates to the member information include updates to member's health-related information, for example, details regarding member's visit, details regarding treatment, prescriptions, and/or other information. In some implementations, smart health card interaction module 314 of provider 104 may communicate the updated member information to the mobile device 600. SIM card interaction module 616 of mobile device 600 may receive the updated information from provider 104 and update the information on the SIM card 630 appropriately.

In some implementations, smart health card interaction module 314 may update the member information on the SIM card via the reader at provider 104.

In some implementations of the invention, provider 104 may update the member information directly at the remote server 204 associated with third-party service provider 110 via server update module 316. In some implementations, provider 104 may update the member information by synchronizing updates to member information on the SIM card 630 with member information at the remote server 204.

In some implementations, the mobile device 600 may comprise a server update module 618 similar to the server update module 316 of provider 104. In some implementations, the server update module 618 may update the member information at the remote server and synchronize the member information on the SIM card 630 with the member information at the remote server 204.

In some implementations of the invention, the application described with respect to FIG. 6 may be resident on the SIM card 630 and mobile device 600 may be configured to run the application resident on SIM card 630. The application and the member information may be stored in a separate areas of the SIM card.

In some implementation of the invention, more of less of the aforementioned software modules may be used and/or combined. In some implementation, the operations of the processes/methods described herein may be performed in an order different from the order given above and may include performance of additional operations. In some implementations, not all operations maybe necessary.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for providing health care services using subscriber identity module (SIM) cards, comprising:
accessing a SIM card to obtain member information;
retrieving an electronic form associated with a HIPAA compliant EDI transaction;
automatically populating the retrieved electronic form associated with the HIPAA compliant EDI transaction with member information obtained from the SIM card;
forwarding the populated electronic form associated with the HIPAA compliant EDI transaction; and
updating the member information on the SIM card based on diagnosis and treatment.

2. The method of claim 1, further comprising synchronizing the updated member information on the SIM card with member information at a remote server.

3. The method of claim 2, further comprising directly updating the remote server with the updated member information.

4. The method of claim 1, wherein the member information includes health-related, demographic information and provider information.

5. The method of claim 1, wherein forwarding the populated electronic form further comprising forwarding the populated electronic form to a payer.

6. The method of claim 1, wherein the HIPAA compliant EDI transaction includes one or more from the set of: member eligibility request, claim, or claim status request.

7. The method of claim 5, further comprising:
after forwarding the electronic form to the payer, receiving a response from the payer, the response including one or more of: member eligibility response, claim response, or claim status response.

8. The method of claim 1, wherein the electronic form is retrieved from at least one of the SIM card, a local provider system, or a remote server.

9. A provider system for providing health care services using SIM cards, comprising:
a smart health card reading module that accesses a SIM card to obtain member information;
an EDI transaction generating module that:
retrieves an electronic form associated with a HIPAA compliant EDI transaction;
populates the electronic form associated with the HIPAA compliant EDI transaction with member information obtained from the SIM card;
forwards the populated electronic form associated with the HIPAA compliant EDI transaction; and
a smart health card interaction module that updates member information on the SIM card based on diagnosis and treatment.

10. The provider system of claim 9, wherein the smart health card interaction module alerts a provider of updates available at a server for the member whose SIM card is being accessed.

11. The provider system of claim 9, further comprising:
a server update module that updates member information directly at a remote server or by synchronizing updates to member information on the SIM card with member information at the remote server.

12. The provider system of claim 9, wherein the EDI transaction generating module forwards the populated electronic form to a payer.

13. The provider system of claim 9, wherein the HIPAA compliant EDI transaction includes one or more from the set of: member eligibility request, claim, or claim status request.

14. The provider system of claim 14, wherein the EDI transaction generating module further receives, from the payer, a response to the forwarded form, the response including one or more of: member eligibility response, claim response, or claim status response.

15. The provider system of claim 9, wherein the EDI transaction generating module further retrieves the electronic form from at least one of: the SIM card, a memory in the provider system or a remote server.

16. A system for providing health care services using SIM cards, comprising:
a mobile device associated with a member including a SIM card that stores member information associated with the member, the mobile device comprising one or more modules configured to:
access the SIM card to obtain the member information;
retrieve an electronic form associated with a HIPAA compliant EDI transaction;
populate the electronic form associated with the HIPAA compliant EDI transaction with the member information obtained from the SIM card; and
forward the populated electronic form associated with the HIPAA compliant EDI transaction.

17. The system of claim 16, wherein the one or more modules of the mobile device further configured to:
generate one or more requests to obtain initial member information;
receive the initial member information; and
store the received initial member information in the SIM card.

18. The system of claim 16, wherein the one or more modules of the mobile device further configured to:
receive updates to the member information; and
store the updated member information in the SIM card.

19. The system of claim 16, further comprising:
a provider system comprising one or more modules configured to update member information on the SIM card based on diagnosis and treatment.

20. The system of claim 19, wherein the one or more modules of the mobile device further configured to:
update the member information directly at a remote server or by synchronizing updates to the member information on the SIM card with member information at the remote server.

21. The system of claim 16, wherein the one or more modules of the mobile device further configured to:
alert a provider of updates available at a server for the member whose SIM card is being accessed.

22. The system of claim 16, wherein the one or more modules of the mobile device further configured to:
alert the member of updates available at a server for the member, either prior to, during or after a visit to the provider.

23. The system of claim 16, wherein the one or more modules of the mobile device further configured to:
forward the populated electronic form to a payer.

24. The system of claim 16, wherein the HIPAA compliant EDI transaction includes one or more from the set of: member eligibility request, claim, or claim status request.

25. The system of claim 24, wherein the one or more modules of the mobile device further configured to:
receive, from the payer, a response to the forwarded form, the response including one or more of: member eligibility response, claim response or claim status response.

26. The system of claim 23, wherein the one or more modules of the mobile device further configured to:
retrieve the electronic form from at least one of: the SIM card, a memory in a provider system or a remote server.
